(19) United States
(12) Patent Application Publication
(10) Pub. No.: US 2022/0253910 A1
(43) Pub. Date: Aug. 11, 2022

(54) VEHICLE ASSESSMENT SYSTEM, VEHICLE ASSESSMENT METHOD, AND VEHICLE ASSESSMENT PROGRAM

(71) Applicant: TOYOTA JIDOSHA KABUSHIKI KAISHA, Aichi-ken (JP)

(72) Inventors: Takeshi MURAKAMI, Okazaki-shi (JP); Kenji YAMAGUCHI, Toyota-shi (JP)

(21) Appl. No.: 17/578,466

(22) Filed: Jan. 19, 2022

(30) Foreign Application Priority Data
Feb. 10, 2021 (JP) 2021-019913

(51) Int. Cl. G06Q 30/02

(52) U.S. Cl. CPC G06Q 30/0278

(57) ABSTRACT

A vehicle assessment system includes a report information evaluation unit. The report information evaluation unit is configured to adjust a report information-based evaluated price based on report information, from an appraisal price assessed by a vehicle appraisal price determination unit according to an elapsed time from a time when a report information database has acquired the report information.

### CROSS-REFERENCE TO RELATED APPLICATION

This application claims priority to Japanese Patent Application No. 2021-019913 filed on Feb. 10, 2021, incorporated herein by reference in its entirety.

### BACKGROUND

### 1. Technical Field

This present disclosure relates to a vehicle assessment system, a vehicle assessment method, and a vehicle assessment program.

### 2. Description of Related Art

Japanese Unexamined Patent Application Publication No. 2006-107409 discloses a vehicle price assessment method. In this vehicle price assessment method, a vehicle price is assessed by using self-reported data on a vehicle provided by a vehicle owner as one type of basic vehicle assessment data.

### SUMMARY

The self-reported data shows a vehicle state when the self-reported data is submitted, and as a time has elapsed from a time of providing the self-reported data, the self-reported data may deviate from the actual vehicle state.

In the above related art, the elapsed time since the self-reported data is submitted is not reflected in the vehicle appraisal price, thus the method can be further improved such that the vehicle appraisal price is more accurately determined based on the elapsed time.

Considering the facts stated above, the present disclosure is intended to provide a vehicle assessment system, a vehicle assessment method, and a vehicle assessment program, each of which is capable of reflecting report information on a vehicle, input by a vehicle owner, in a vehicle appraisal price, while assessing such a vehicle appraisal price more accurately according to an elapsed time from a time when the report information has been submitted.

A vehicle assessment system according to a first aspect of the present disclosure includes a terminal used by a vehicle owner who owns a vehicle to be assessed, a report information acquisition unit configured to acquire, via a network, report information on a vehicle state from the terminal into which the report information is input by the vehicle owner, a vehicle appraisal price determination unit configured to assess an appraisal price of the vehicle by evaluating the vehicle with the report information as one of pieces of assessment information, and a report information evaluation unit configured to adjust a report information-based evaluated price based on the report information, from the appraisal price, according to an elapsed time from a time when the report information is acquired by the report information acquisition unit.

In the above configuration, the vehicle owner who owns the vehicle to be assessed inputs the report information on the vehicle state into a terminal used by the vehicle owner, and the report information acquisition unit is configured to acquire, via a network, the report information from the terminal. The vehicle appraisal price determination unit assesses an appraisal price of the vehicle by evaluating the vehicle with the report information as one of the pieces of assessment information.

The report information shows a vehicle state when the report information is submitted, and as time has elapsed from a time of providing the report information, the report information may deviate from the actual vehicle state.

The vehicle assessment system of the present disclosure includes the report information evaluation unit. The report information evaluation unit adjusts the report information-based evaluated price based on the report information, from the appraisal price assessed by the vehicle appraisal price determination unit, according to the elapsed time from the time when the report information is acquired by the report information acquisition unit. Consequently, it is possible to reflect the elapsed time from the time when the report information has been acquired in the appraisal price of the vehicle.

In the first aspect, the vehicle assessment system may further include a vehicle state information acquisition unit configured to acquire vehicle state information on a vehicle state via the network. The vehicle state information is detected by a sensor mounted on the vehicle. The vehicle appraisal price determination unit may determine the appraisal price of the vehicle by evaluating the vehicle with the vehicle state information as one of the pieces of assessment information.

In the above configuration, the vehicle state is detected by the sensor arranged on the vehicle. The vehicle state information acquisition unit acquires, via the network, the vehicle state information detected by the sensor. The vehicle appraisal price determination unit assesses the vehicle state information as one of the pieces of assessment information in order to determine the appraisal price of the vehicle. Accordingly, the vehicle can be assessed without a direct check of the vehicle state by, for example, visual inspection in the present disclosure.

In the first aspect, the report information may include exterior information on an exterior of the vehicle, interior information on an interior of the vehicle, and odor information on odor in a vehicle compartment of the vehicle. The report information-based evaluated price may include an appearance-based evaluated price based on the exterior information, an interior-based evaluated price based on the interior information, and an odor-based evaluated price based on the odor information. Further, the report information evaluation unit may be configured to independently set a correlation between the appearance-based evaluated price and the elapsed time, a correlation between the interior-based evaluated price and the elapsed time, and a correlation between the odor-based evaluated price and the elapsed time.

In the above configuration, the report information acquisition unit acquires the exterior information on the exterior of the assessed vehicle, the interior information on the interior of such a vehicle, and the odor information on the odor in the vehicle compartment of the vehicle. The report information-based evaluated price includes the appearance-based evaluated price based on the exterior information, the interior-based evaluated price based on the interior information, and the odor-based evaluated price based on the odor information.

It is likely that the exterior information, the interior information, and the odor information may deviate from the actual vehicle state as a time has elapsed from a time of acquiring those pieces of information, and each information may have its own deviation degree.

Consequently, in the present disclosure, the report information evaluation unit is configured to independently set the correlation between the appearance-based evaluated price and the elapsed time, the correlation between the interior-based evaluated price and the elapsed time, and the correlation between the odor-based evaluated price and the elapsed time. Therefore, the report information-based evaluated price can be assessed more accurately in the present disclosure.

In the first aspect, the report information evaluation unit may be configured to reduce the report information-based evaluated price according to the elapsed time, and to issue a notification to the terminal, via the network, in a case where the report information-based evaluated price drops to or below a price corresponding to a predetermined ratio of a price when the report information is acquired.

In the above configuration, the report information evaluation unit reduces the report information-based evaluated price according to the elapsed time from the time when the report information is acquired. The report information evaluation unit also issues the notification to the terminal used by the vehicle owner, via the network, in a case where the report information-based evaluated price drops to or below the price corresponding to the predetermined ratio of the price when the report information is acquired. Therefore, in the present disclosure, it is possible to request the vehicle owner, who owns the vehicle to be assessed, to update the report information on the vehicle state.

A vehicle assessment method according to a second aspect of the present disclosure includes acquiring report information on a vehicle state of a vehicle to be assessed from a terminal into which the report information is input by a vehicle owner who owns the vehicle, assessing an appraisal price of the vehicle by evaluating the vehicle with the report information as one of pieces of assessment information, and adjusting a report information-based evaluated price based on the report information, from the appraisal price, according to an elapsed time from a time when the report information is acquired.

In the above configuration, the report information on the vehicle state of the vehicle is acquired from the terminal into which the information input by the vehicle owner who owns the vehicle to be assessed. The appraisal price of the vehicle is assessed by evaluating the vehicle with report information as one of the pieces of assessment information.

In the present disclosure, the report information-based evaluated price based on the report information is adjusted from the appraisal price of the vehicle according to the elapsed time from the time when the report information is acquired. Consequently, it is possible to reflect the elapsed time from the time when the report information is acquired in the appraisal price of the vehicle.

A vehicle assessment program according to a third aspect of the present disclosure causes a computer to execute acquiring report information on a vehicle state of a vehicle to be assessed from a terminal into which the report information is input by a vehicle owner who owns the vehicle, assessing an appraisal price of the vehicle by evaluating the vehicle with the report information as one of pieces of assessment information, and adjusting a report information-based evaluated price based on the report information, from the appraisal price, according to an elapsed time from a time when the report information is acquired. Consequently, it is possible to reflect the elapsed time from the time when the report information is acquired in the appraisal price of the vehicle in the present disclosure, similar to the method according to the second aspect.

As stated above, the vehicle assessment system, the vehicle assessment method, and the vehicle assessment program, according to each aspect of the present disclosure, have advantageous effects wherein each is capable of reflecting report information on the vehicle, input by the vehicle owner, in the vehicle appraisal price, while assessing such a vehicle appraisal price more accurately according to the elapsed time from the time when the report information has been submitted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram schematically illustrating a configuration of a vehicle assessment system according to the present embodiment;

FIG. 2 is a block diagram illustrating a hardware configuration of a vehicle control device constituting a part of the vehicle assessment system according to the present embodiment;

FIG. 3 is a block diagram illustrating a hardware configuration of a server constituting a part of the vehicle assessment system according to the present embodiment;

FIG. 4 is a block diagram illustrating a functional configuration of the vehicle assessment system according to the present embodiment;

FIG. 5 is one example of a basic vehicle information data table stored in the server constituting a part of the vehicle assessment system according to the present embodiment;

FIG. 6 is one example of a vehicle state information data table stored in the server constituting a part of the vehicle assessment system according to the present embodiment;

FIG. 7 is one example of a report information data table stored in the server constituting a part of the vehicle assessment system according to the present embodiment;

FIG. 8 is one example of a report information-based evaluated price data table stored in the server constituting a part of the vehicle assessment system according to the present embodiment;

FIG. 9 is a diagram illustrating one example of a correlation between an elapsed time and a vehicle appraisal price acquired by the vehicle assessment system according to the present embodiment; and

FIG. 10 is a flowchart illustrating one example of a flow of a vehicle assessment by the vehicle assessment system according to the present embodiment.

### DETAILED DESCRIPTION OF EMBODIMENTS

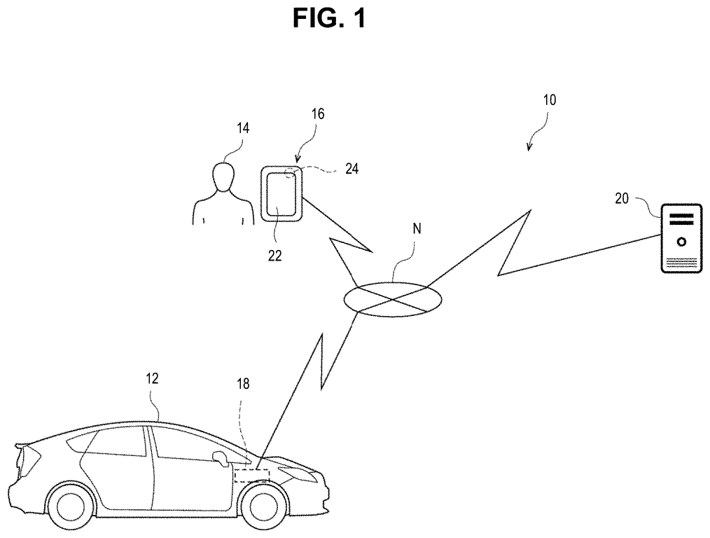

One example of an embodiment of a vehicle assessment system 10 according to the present disclosure will described hereinbelow referring to FIGS. 1 to 10. As shown in FIG. 1, the vehicle assessment system 10 includes a terminal 16 used by a vehicle owner 14, who owns a vehicle 12 to be assessed, a vehicle control device 18 mounted on the vehicle 12, a server 20, and a network N connecting these elements for establishing communication therebetween.

As one example, the terminal 16 is a portable terminal provided with a display 22 capable of displaying various pieces of information to the vehicle owner 14, as well as a camera 24. Various devices can be adopted as the terminal 16, for example, a smartphone or a tablet. The terminal 16 can establish communication with, for example, the server 20 via the network N.

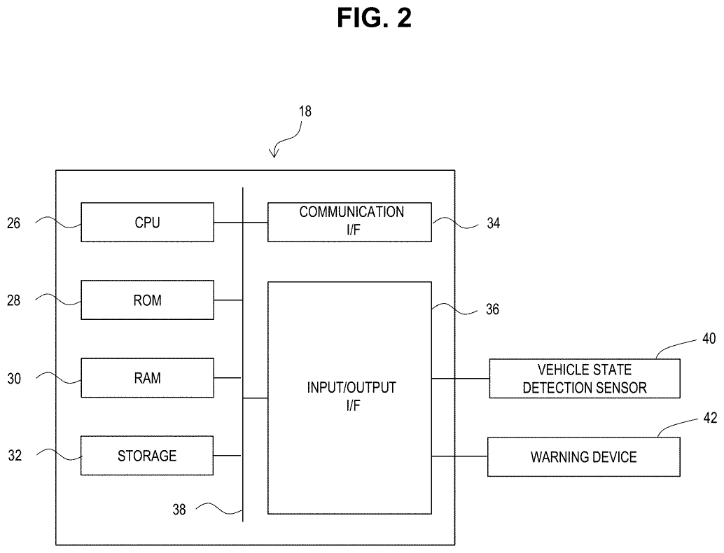

As shown in FIG. 2, the vehicle control device 18 is configured to include a CPU (central processing unit) 26, one example of a processor, a ROM (read only memory) 28, a RAM (random access memory) 30, a storage 32, a communication I/F (interface) 34, and an input/output I/F 36. The CPU 26, the ROM 28, the RAM 30, the storage 32, the communication I/F 34, and the input/output I/F 36 are connected to each other so as to establish communication therebetween via a bus 38.

The CPU 26 is a central processing unit, which can execute various programs related to various controls of the vehicle 12. In particular, the CPU 26 can read the execution program from the ROM 28 and execute such a program using the RAM 30 as a work area. As the execution program stored in the ROM 28 is read out by the CPU 26 and executed, the vehicle control device 18 can provide various functions as described later.

The storage 32 is configured to include a hard disk drive (HDD) or a solid state drive (SSD), which stores various programs including an operating system and various data. Further, the storage 32 can store various pieces of information of the vehicle 12, as described later.

The communication I/F 34 is an interface used for connecting the vehicle control device 18 and the network N. The communication I/F 34 can establish communication with, for example, the server 20 via the network N. For example, communication protocols such as Ethernet (registered trademark), FDDI, and Wi-Fi (registered trademark) are used as the interface.

The input/output I/F 36 is an interface for the vehicle control device 18 to establish communication with each device mounted on the vehicle 12. The vehicle control device 18 is connected to each device, described later, via the input/output I/F 36 so as to establish communication therebetween. These devices may be directly connected to the bus 38.

A vehicle state detection sensor 40 and a warning device 42 are connected to the input/output I/F 36, as sensors arranged on the vehicle 12. The vehicle state detection sensor 40 is a group of sensors used for detecting a state of each device mounted on the vehicle 12, which includes, for example, a travel distance meter, an air flow meter, a vacuum sensor, a steering sensor, and the like. Each data acquired by the vehicle state detection sensor 40 is temporarily stored in the storage 32, and is transmitted from the communication I/F 34 to the server 20.

Meanwhile, the warning device 42 is a group of sensors for detecting a failure of each device mounted on the vehicle 12, which includes, for example, a brake sensor, an engine sensor, an anti-lock brake system (ABS) sensor, a power steering sensor, and the like. The data, for example data on display history of a warning lamp by the warning device 42, is temporarily stored in the storage 32, and is transmitted from the communication I/F 34 to the server 20.

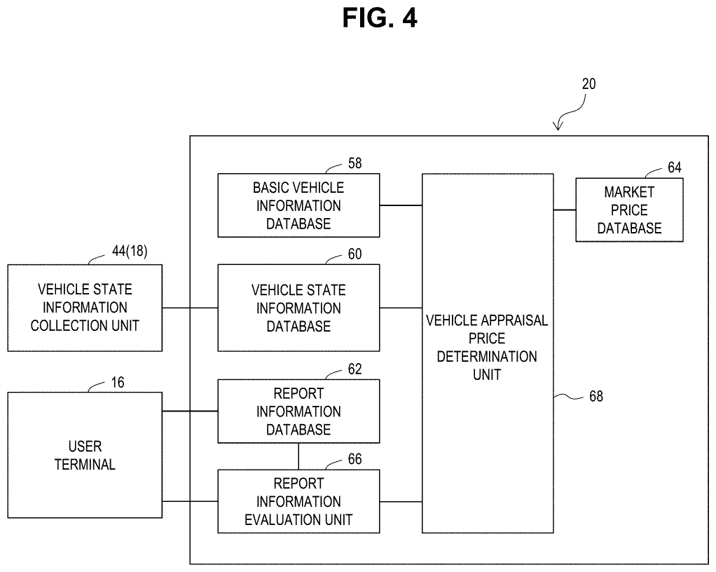

The functional configuration implemented by the vehicle control device 18 will be described. As shown in FIG. 4, the vehicle control device 18 functions as a vehicle state information collection unit 44 by the CPU 26 reading the execution program stored in the ROM 28 and executing such a program.

The vehicle state information collection unit 44 acquires various pieces of data from the vehicle state detection sensor 40 and the warning device 42, compiles these pieces of data, and transmits the data to the server 20 at predetermined intervals.

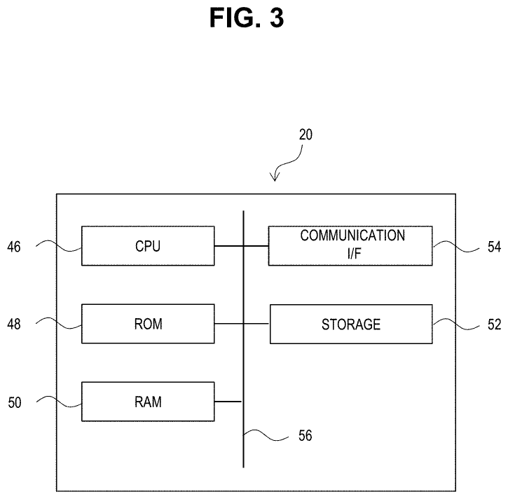

Meanwhile, as shown in FIG. 3, the server 20 is configured to include a CPU 46, a ROM 48, a RAM 50, a storage 52, and a communication I/F 54. Further, the CPU 46, the ROM 48, the RAM 50, the storage 52, and the communication I/F 54 are connected to each other so as to establish communication therebetween via a bus 56. The CPU 46, ROM 48, RAM 50, storage 52, and communication I/F 54 have functions substantially the same as those constituting the vehicle control device 18 described above.

In the present embodiment, the execution program related to the vehicle assessment and stored in the ROM 48 is read and executed by the CPU 46, such that the appraisal price of the vehicle 12 is assessed based on various data associated with the assessment of the vehicle 12 and stored in the storage 52.

More specifically, as shown in FIG. 4, the server 20 reads the execution program stored in the ROM 48 by the CPU 46 and executes such a program to function as an assembly of a basic vehicle information database 58, a vehicle state information database 60 as a vehicle state information acquisition unit, a report information database 62 as a report information acquisition unit, a market price database 64, a report information evaluation unit 66, and a vehicle appraisal price determination unit 68.

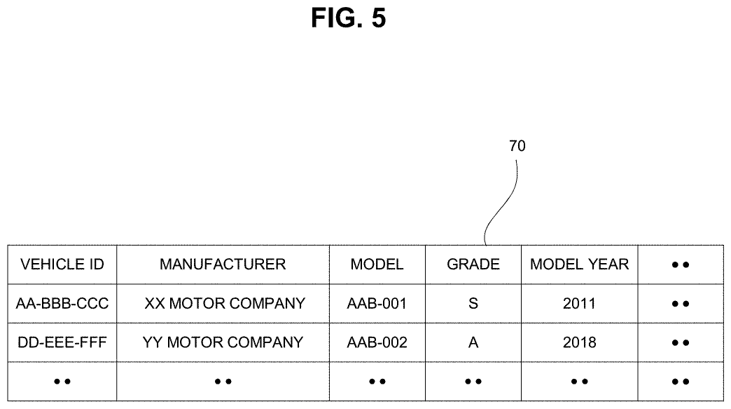

The basic vehicle information database 58 is a database in which basic information of a plurality of vehicles to be assessed is stored, and which stores a basic vehicle information data table 70, associated with a vehicle ID (identification) assigned to the vehicle to be assessed, as well as manufacturer, model, grade and model year of such a vehicle, as shown in FIG. 5.

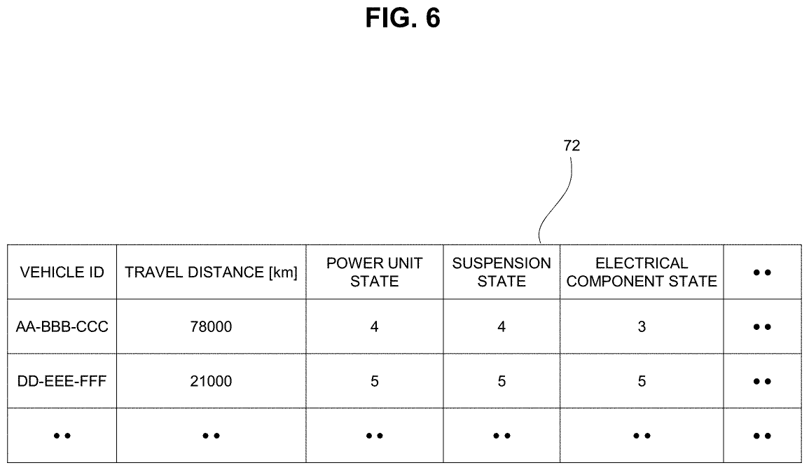

The vehicle state information database 60 is a database which stores the vehicle state information of a plurality of vehicles to be assessed, and which can store various data acquired from the vehicle state information collection unit 44. As shown in FIG. 6, the vehicle state information database 60 stores a vehicle state information data table 72 associated with a vehicle ID assigned to the vehicle to be assessed, as well as travel distance, power unit state evaluation scores, suspension state evaluation scores, and electrical component state evaluation scores of such a vehicle.

The power unit state evaluation scores, the suspension state evaluation scores, and the electrical component state evaluation scores are each quality evaluation scores evaluated by a reviewer or artificial intelligence (AI), on a 1-5 rating scale, based on various data acquired from the vehicle state information collection unit 44.

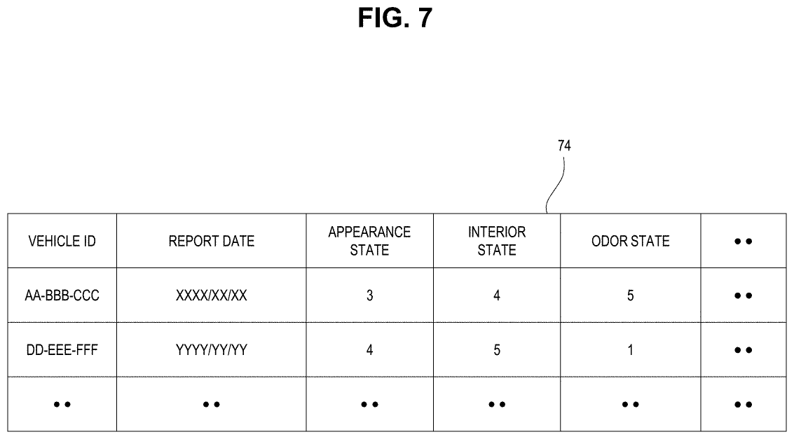

The report information database 62 acquires the report information on the vehicle state of the vehicle 12 input into the terminal 16 by the vehicle owner 14 via the network N, which is capable of storing the report information. As shown in FIG. 7, the report information database 62 stores a report information data table 74 associated with a vehicle ID assigned to the vehicle to be assessed, as well as a date when the report information of such a vehicle has been submitted, and appearance state evaluation scores, interior state evaluation scores, and odor state evaluation scores of such a vehicle.

In particular, the report information input by the vehicle owner 14 into the terminal 16 includes the exterior information, i.e., image data of the appearance of the vehicle 12, captured by the vehicle owner 14 with the terminal 16, the interior information, i.e., image data of the interior of the vehicle 12, captured by the vehicle owner 14 with the terminal 16, and the odor information, i.e., data on a weekly average smoking time in the vehicle 12 and data on a weekly average eating/drinking time in the vehicle 12.

The appearance state evaluation scores, the interior state evaluation scores, and the odor state evaluation scores are each quality evaluation scores evaluated by the reviewer or artificial intelligence (AI), on a 1-5 rating scale, based on various data included in the report information.

The report information evaluation unit 66 assesses a report information-based evaluated price PA, which is a part of the appraisal price of the vehicle 12, based on the report information data table 74.

In particular, the report information-based evaluated price PA includes an appearance markup as an appearance-based evaluated price, an interior markup as an interior-based evaluated price, and an odor markup as an odor-based evaluated price. The report information evaluation unit 66 assesses an initial appearance markup based on the appearance state evaluation scores of the report information data table 74 with a predetermined conditional expression, an initial interior markup based on the interior state evaluation scores of the report information data table 74 with a predetermined conditional expression, and an initial odor markup based on the odor state evaluation scores of the report information data table 74.

Further, in the present embodiment, the report information evaluation unit 66 counts an elapsed time from the time when the report information has been acquired (hereinafter simply referred to as the “elapsed time”) at predetermined intervals since the report information database 62 has acquired the report information, and adjusts the report information-based evaluated price PA according to the elapsed time. In particular, the report information evaluation unit 66 is set to decrease the report information-based evaluated price PA according to the elapsed time, based on an initial value of the report information-based evaluated price PA. Moreover, the report information evaluation unit 66 independently sets a correlation between the appearance markup and the elapsed time, a correlation between the interior markup and the elapsed time, and a correlation between the odor markup and the elapsed time.

In the present embodiment, as one example, when the appearance markup is A1 (JPY), the initial appearance markup is A0 (JPY), and the elapsed time is D (days), a correlation of A1=A0−A0×(D/90) is established. When the elapsed time is 90 days or more, the appearance markup is JPY 0.

When the interior markup is B1 (JPY), the initial interior markup is B0 (JPY), and the elapsed time is D (days), a correlation of B1=B0−B0×(D/120) is established. When the elapsed time is 120 days or more, the interior markup is JPY 0.

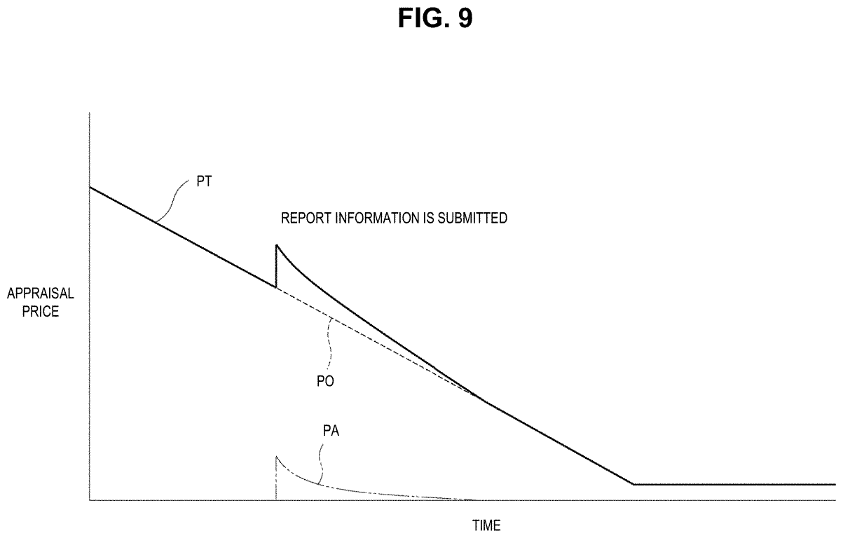

Further, when the odor markup is C1 (JPY), the initial odor markup is C0 (JPY), and the elapsed time is D (days), a correlation of C1=C0−C0×(D/30) is established. When the elapsed time is 30 days or more, the odor markup is JPY 0. Moreover, the report information-based evaluated price PA is a graph shown by a two-dot chain line in FIG. 9.

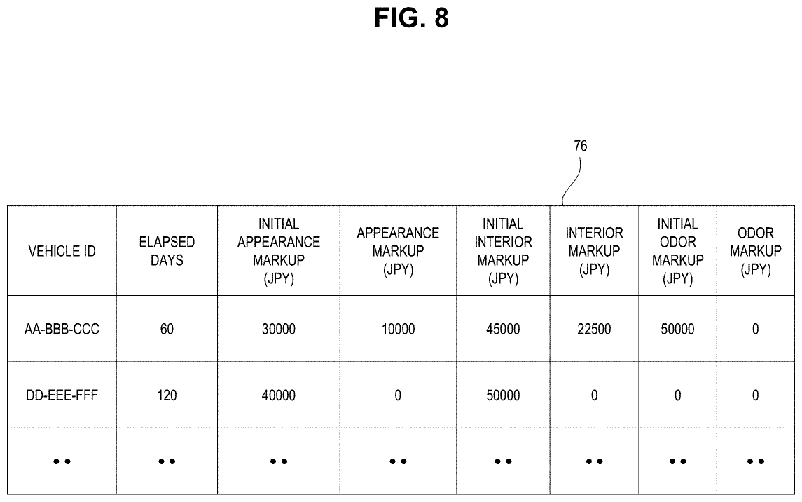

As shown in FIG. 8, the report information evaluation unit 66 stores a report information-based evaluated price data table 76 associated with a vehicle ID assigned to the vehicle to be assessed, as well as elapsed time, initial appearance markup, appearance markup, initial interior markup, interior markup, initial odor markup, and odor markup of such a vehicle.

Further, when the report information-based evaluated price PA drops to or below a price corresponding to a predetermined ratio of the initial report information-based evaluated price PA, the report information evaluation unit 66 can issue to the terminal 16, via the network N, the notification notifying that the report information-based evaluated price PA is reduced. In the present embodiment, as one example, when the report information-based evaluated price PA becomes JPY 0, the report information evaluation unit 66 issues the notification to the terminal 16.

The market price database 64 is a database that stores assessed prices of second-hand vehicles sold in a market, acquired from an external terminal (not shown), and includes a market price data table (not shown) associated with a vehicle ID, manufacturer, model, grade, model year, vehicle state and assessed price of a certain second-hand vehicle.

The vehicle appraisal price determination unit 68 compares the data of the vehicle 12, stored in the basic vehicle information database 58 and the vehicle state information database 60, with the data stored in the market price database 64, and thus assesses the standard appraisal price PO of the vehicle 12. Moreover, the standard appraisal price PO is a graph shown by a dotted line in FIG. 9.

The vehicle appraisal price determination unit 68 adds the report information-based evaluated price PA, assessed by the report information evaluation unit 66, to the standard appraisal price PO to determine an appraisal price PT of the vehicle 12. That is, in the present embodiment, it can also be understood that the report information evaluation unit 66 serves as a part of the vehicle appraisal price determination unit 68. Moreover, the appraisal price PT is a graph shown by a solid line in FIG. 9.

The vehicle appraisal price determination unit 68 transmits the appraisal price PT of the vehicle 12 to the terminal 16 via the network N. When the report information evaluation unit 66 issues the notification to the terminal 16, the vehicle appraisal price determination unit 68 transmits, to the terminal 16, the appraisal price PT.

### Operation and Effect of Present Embodiment

The operation and effect of the present embodiment will be described hereinbelow.

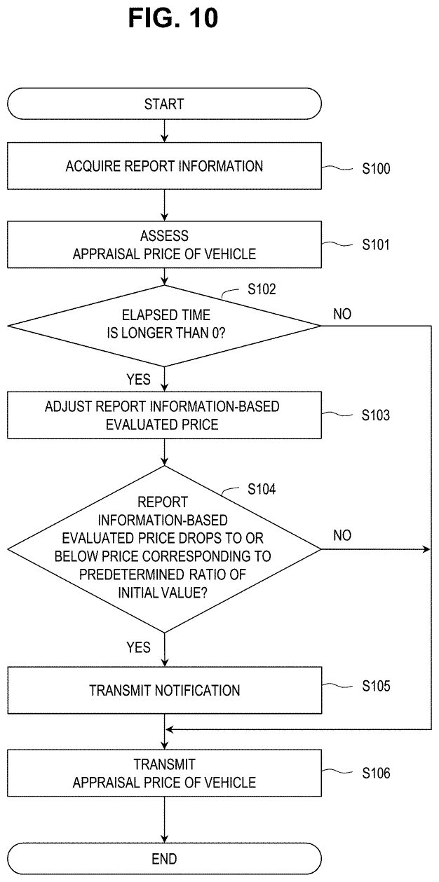

A vehicle assessment flow by the program executed by the CPU 46 of the server 20 will be described with reference to FIG. 10. This vehicle assessment flow is initiated when the CPU 46 receives a predetermined instruction signal.

When this assessment flow is initiated, the CPU 46 acquires the report information on the vehicle state of the vehicle 12 from the report information database 62 to assess the initial report information-based evaluated price PA in step S100, and then proceeds to step S101.

The CPU 46 assesses the standard appraisal price PO of the vehicle 12, adds the report information-based evaluated price PA to the standard appraisal price PO to assess the appraisal price PT of the vehicle 12 in step S101, and then proceeds to step S102.

The CPU 46 counts the elapsed time D (the number of elapsed days) from the time when the report information of the vehicle 12 has been acquired in step S102, and then proceeds to step S103 in a case where the elapsed time D is longer than 0 days (step S102: YES), or proceeds to step S106 in a case where the elapsed time D is 0 days (step S102: NO).

The report information-based evaluated price PA is adjusted from the initial value according to the elapsed time D from the time when the report information of the vehicle 12 has been acquired to confirm the appraisal price PT in step S103. The CPU 46 proceeds to step S104.

The CPU 46 determines whether or not the report information-based evaluated price PA drops to or below the price corresponding to the predetermined ratio of the initial report information-based evaluated price PA in step S104, and then proceeds to step S105 in a case where the report information-based evaluated price PA drops to or below the price corresponding to the predetermined ratio of the initial value (step S104: YES), or proceeds to step S106 in a case where the report information-based evaluated price PA does not drop to or below the price corresponding to the predetermined ratio of the initial value (step S104: NO).

In step S105, the CPU 46 issues the notification to the terminal 16 notifying that the report information-based evaluated price PA is reduced, and proceeds to step S106.

The CPU 46 transmits the confirmed appraisal price PT to the terminal 16 and ends the assessment flow in step S106.

As stated above, in the present embodiment, the vehicle owner 14, who owns a vehicle 12 to be assessed, inputs the report information on the vehicle state of the vehicle 12 into the terminal 16 used by the vehicle owner 14, and the report information database 62 acquires the report information from the terminal 16 via the network N, as shown in FIG. 4. The vehicle appraisal price determination unit 68 evaluates the report information as one of the pieces of assessment information in order to assess the appraisal price PT of the vehicle 12.

The report information shows a vehicle state of the vehicle 12 when the report information is submitted, and as a time has elapsed from the time of providing the report information, the report information may deviate from the actual vehicle state of the vehicle 12.

The system according to the present embodiment includes the report information evaluation unit 66. The report information evaluation unit 66 adjusts the report information-based evaluated price PA based on the report information, from the appraisal price PT assessed by the vehicle appraisal price determination unit 68 according to the elapsed time D from the time when the report information database 62 has acquired the report information. Consequently, it is possible to reflect the elapsed time D from the time when the report information has been acquired in the appraisal price PT of the vehicle 12.

Further, in the present embodiment, the vehicle state of the vehicle 12 is detected by the vehicle state detection sensor 40 and the warning device 42 arranged on the vehicle 12. The vehicle state information detected by the vehicle state detection sensor 40 and the warning device 42 is acquired by the vehicle state information database 60 via the network N. The vehicle appraisal price determination unit 68 evaluates the vehicle state information as one of the pieces of assessment information in order to determine the appraisal price PT of the vehicle 12. Accordingly, in the present embodiment, the vehicle 12 can be assessed without a direct check of the vehicle state of the vehicle 12 by, for example, visual inspection.

Further, in the present embodiment, the report information database 62 acquires the image data of the appearance of the vehicle 12, and the image data of the interior of the vehicle 12, as well as the data on the weekly average smoking time and the data on the weekly average eating/drinking time in the vehicle 12. The report information-based evaluated price PA includes the appearance markup A1 based on the exterior information, the interior markup B1 based on the interior information, and the odor markup C1 based on the odor information.

Those pieces of data, i.e., the image data of the appearance of the vehicle 12 and the image data of the interior of the vehicle 12, as well as the data on the weekly average smoking time and the data on the weekly average eating/drinking time in the vehicle 12, may respectively deviate from the actual vehicle state of the vehicle 12 as a time has elapsed from the time of acquiring said data. However, each type of data may have its own deviation degree.

In the present embodiment, the report information evaluation unit 66 independently sets the correlation between the appearance markup A1 and the elapsed time D, the correlation between the interior markup B1 and the elapsed time D, and the correlation between the odor markup C1 and the elapsed time D. Therefore, the report information-based evaluated price PA can be assessed more accurately in the present embodiment.

Additionally, in the present embodiment, the report information evaluation unit 66 reduces the report information-based evaluated price PA according to the elapsed time D from the time when the report information has been acquired. The report information evaluation unit 66 also issues the notification to the terminal 16, via the network N, when the report information-based evaluated price PA drops to or below the price corresponding to the predetermined ratio of the price when the report information is acquired. Therefore, in the present embodiment, it is possible to request that the vehicle owner 14 updates the report information on the vehicle state of the vehicle 12.

As described above, in the present embodiment, the report information on the vehicle 12, input by the vehicle owner 14, can be reflected in the appraisal price PT of the vehicle 12, while the appraisal price PT of the vehicle 12 can be adjusted more accurately according to the elapsed time D from the time when the report information is acquired.

### Supplementary Description of Embodiment

(1) In the embodiment stated above, an image taken by the vehicle owner 14 with the terminal 16 is adopted as the appearance image data of the vehicle 12 included in the report information. However, the present disclosure is not limited thereto. For example, equipment or devices capable of capturing an image of the appearance of the vehicle may be arranged in a predetermined facility, e.g., a gas station, and the appearance image data of the vehicle 12 may be acquired by using such equipment or devices.

(2) Further, in the embodiment stated above, the odor information is the data on the weekly average smoking time and the data on the weekly average eating/drinking time in the vehicle 12, and the present disclosure is not limited thereto. For example, an odor sensor may be arranged in the vehicle compartment of the vehicle 12, and the data obtained by the odor sensor may be employed as the odor information.

What is claimed is:

1. A vehicle assessment system comprising:
a terminal used by a vehicle owner who owns a vehicle to be assessed;
a report information acquisition unit configured to acquire, via a network, report information on a vehicle state from the terminal into which the report information is input by the vehicle owner;
a vehicle appraisal price determination unit configured to assess an appraisal price of the vehicle by evaluating the vehicle with the report information as one of pieces of assessment information; and
a report information evaluation unit configured to adjust a report information-based evaluated price based on the report information, from the appraisal price, according to an elapsed time from a time when the report information is acquired by the report information acquisition unit.

2. The vehicle assessment system according to claim 1, further comprising:
a vehicle state information acquisition unit configured to acquire vehicle state information on the vehicle state via the network, the vehicle state information being detected by a sensor mounted on the vehicle,
wherein the vehicle appraisal price determination unit is configured to determine the appraisal price of the vehicle by evaluating the vehicle with the vehicle state information as one of the pieces of assessment information.

3. The vehicle assessment system according to claim 1, wherein:
the report information includes exterior information on an exterior of the vehicle, interior information on an interior of the vehicle, and odor information on odor in a vehicle compartment of the vehicle;
the report information-based evaluated price includes an appearance-based evaluated price based on the exterior information, an interior-based evaluated price based on the interior information, and an odor-based evaluated price based on the odor information; and
the report information evaluation unit is configured to independently set a correlation between the appearance-based evaluated price and the elapsed time, a correlation between the interior-based evaluated price and the elapsed time, and a correlation between the odor-based evaluated price and the elapsed time.

4. The vehicle assessment system according to claim 1, wherein the report information evaluation unit is configured to reduce the report information-based evaluated price according to the elapsed time, and to issue an notification to the terminal via the network in a case where the report information-based evaluated price drops to or below a price corresponding to a predetermined ratio of a price when the report information is acquired.

5. A vehicle assessment method comprising:
acquiring report information on a vehicle state of a vehicle to be assessed from a terminal into which the report information is input by a vehicle owner who owns the vehicle;
assessing an appraisal price of the vehicle by evaluating the vehicle with the report information as one of pieces of assessment information; and
adjusting a report information-based evaluated price based on the report information, from the appraisal price, according to an elapsed time from a time when the report information is acquired.

6. A vehicle assessment program causing a computer to execute:
acquiring report information on a vehicle state of a vehicle to be assessed from a terminal into which the report information is input by a vehicle owner who owns the vehicle;
assessing an appraisal price of the vehicle by evaluating the vehicle with the report information as one of pieces of assessment information; and
adjusting a report information-based evaluated price based on the report information, from the appraisal price, according to an elapsed time from a time when the report information is acquired.
